(19) United States
(12) Patent Application Publication
(10) Pub. No.: US 2015/0013088 A1
(43) Pub. Date: Jan. 15, 2015

(54) FLASHING TOOTHBRUSH

(71) Applicant: SHUMMI ENTERPRISE CO., LTD., TAIPEI CITY (TW)

(72) Inventor: MING-KUEI LI, TAIPEI CITY (TW)

(21) Appl. No.: 14/324,405

(22) Filed: Jul. 7, 2014

(30) Foreign Application Priority Data
Jul. 10, 2013 (CN) 201320409890.2

(51) Int. Cl. A46B 15/00; F21V 23/02; A46B 9/04; F21V 23/04

(52) U.S. Cl. CPC A46B 15/0036; F21V 23/04; F21V 23/023; A46B 9/04; A46B 15/0044; A46B 15/0087
USPC 15/167.1

(57) ABSTRACT

In a lighting toothbrush structure, a front end of a hollow brush handle connects with a brush head. The hollow brush handle is provided with a first transparent patterned layer and a cavity. At least one slide track is arranged on an inside wall of the hollow brush handle. A lighting circuit board is arranged in the hollow brush handle by using the slide track. A switch is protruded from and mounted in the cavity, conveniently pressed by a user. The switch and the brush set belong to an identical side. The switch controls a lighting element to emit light, and the light is projected outside through the first transparent patterned layer. An inner thread of a tail cover is screwed to an outer thread of a rear end of the hollow brush handle to assemble the lighting toothbrush structure with a lighting function.

### BACKGROUND OF THE INVENTION

This application claims priority for Chinese patent application no. 201320409890.2 filed at Jul. 10, 2013, the content of which is incorporated by reference in its entirely.

### FIELD OF THE INVENTION

The present invention relates to a lighting toothbrush structure, particularly to a lighting toothbrush structure with a side thereof provided with a switch to improve operation convenience.

### DESCRIPTION OF THE RELATED ART

Brushing the teeth is widely applied to keep the mouth clean and hygienic, removes food residues and dental plague on tooth surfaces, massages the gums, improves blood circulation, and helps tissue to improve resistance to disease. As a result, brushing can suitably protect the teeth from caries and periodontitis.

Along with people living standard enhancement, the demand for cleanliness, health care and comfort of toothbrushes is higher and higher. Presently, there are all kinds of toothbrushes in the market, such as electric toothbrushes, folding toothbrushes, health-care toothbrushes. disposable toothbrushes, or lighting toothbrushes. These toothbrushes have their advantages and suit for different situations. Take lighting toothbrushes for example. In the market, lighting toothbrushes are divided into two types. One type has a built-in electric circuit. The circuit board with a lighting function is built in a brush handle. A switch is used to turn on a light source to emit light which is projected outside through a brush head or a brush handle made of transparent material, thereby achieving illumination. However, when the power is exhausted, the power supply cannot be replaced. As a result, the lighting toothbrushes are not practical.

In order to overcome the disadvantage, a manufacturer develops another lighting toothbrush with replaceable batteries. Wherein, a circuit board with a lighting function is installed in a brush handle. The batteries are installed in the brush handle and coupled to the circuit board. A thread of a tail cover is screwed to a thread of a tail end of the brush handle, whereby the circuit board and the batteries cannot drop from the brush handle. Although it is convenient for a user to replace the batteries of the lighting toothbrush, no element can be used to fix the circuit board and the batteries in the brush handle. Hence, when a user brushes his teeth, the circuit board and the batteries wobble and collide with the inside wall of the brush handle, whereby the circuit board is easily broken or contact fault of the batteries occur. Thus, the batteries are not normally used. Besides, incorrect locking will break the threads, whereby the circuit board and the batteries are not effectively fixed but even drop off. In addition, since a switch is installed at a rear end of the tail cover, the user has to use another hand to operate the switch. The installation of the switch causes great distress to hand-disabled people. Therefore, how to improve practicality and stability of toothbrushes is the problem to be solved.

To overcome the abovementioned problems, the present invention provides a lighting toothbrush structure, so as to solve the afore-mentioned problems of the prior art.

### SUMMARY OF THE INVENTION

A primary objective of the present invention is to provide a lighting toothbrush structure, which is used with one hand and is operated more easily and conveniently, and which possesses strong market competitiveness.

A secondary objective of the present invention is to provide a lighting toothbrush structure, which has a structural design that can protect an electric circuit. The design features simple structure, easily-repaired and battery-replaced properties and effectively improves practicality and life of products.

Another objective of the present invention is to provide a lighting toothbrush structure, which has entertainment, patterns and an illumination function to attract children to brush their teeth and develop good hygiene habit.

Further objective of the present invention is to provide a lighting toothbrush structure, which has a sucker to support the whole weight, so as to save the expense of a tooth brush holder. The sucker is effectively fixed on but not drops from a smooth plane, and has economic benefits.

To achieve the abovementioned objectives, the present invention provides a lighting toothbrush structure, which comprises a brush head, a hollow brush handle, a lighting circuit board and a tail cover. The brush head is provided with a brush set. The hollow brush handle is provided with a first transparent patterned layer and a cavity. At least one slide track is arranged on an inside wall of the hollow brush handle. A front end of the hollow brush handle connects with the brush head. An outer edge of a rear end of the hollow brush handle is provided with an outer thread. The lighting circuit board has a switch and a lighting element coupled to the switch. The lighting circuit board is arranged in the hollow brush handle by using the slide track. The switch is protruded from and mounted in the cavity. The switch and the brush set belong to an identical side. The switch controls the lighting element to emit light, and the light is projected outside through the first transparent patterned layer. The tail cover is provided with an inner thread inside. The inner thread is screwed to the outer thread whereby the tail cover is fixed at the rear end of the hollow brush handle.

Below, the embodiments are described in detail in cooperation with the drawings to make easily understood the technical contents, characteristics and accomplishments of the present invention.

### BRIEF DESCRIPTION OF THE DRAWINGS

FIG. 1 is a perspective view showing a lighting toothbrush structure according to an embodiment of the present invention;

FIG. 2 is an exploded view of FIG. 1; and

FIG. 3 is a perspective view showing a lighting toothbrush structure according to another embodiment of the present invention.

### DETAILED DESCRIPTION OF THE INVENTION

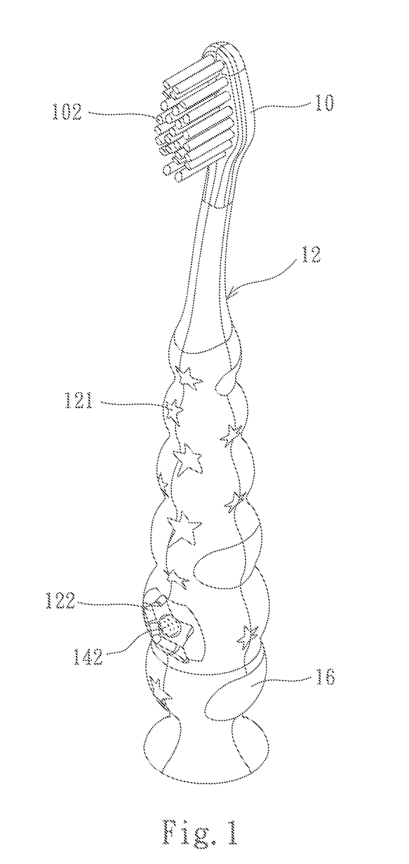

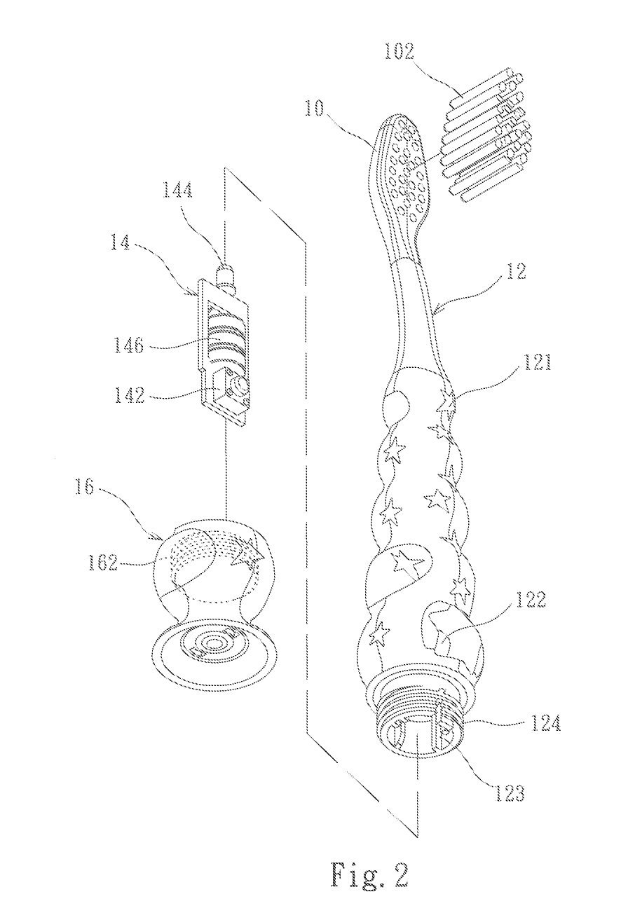

Refer to FIG. 1 and FIG. 2 which are respectively a perspective view and an exploded view of the present invention. The lighting toothbrush structure comprises a brush head 10, a hollow brush handle 12, a lighting circuit board 14, and a tail cover 16. The brush head 10 is provided with a brush set 102, The style and the material of the brush set 102 depend on the requirement for cleaning mouth. The hollow brush handle 12 is provided with a first transparent patterned layer 121 and a cavity 122. At least one slide track 123 is arranged on an inside wail of the hollow brush handle 12. A front end of the hollow brush handle 12 connects with the brush head 10. An outer edge of a rear end of the hollow brush handle 12 is provided with an outer thread 124, The lighting circuit board 14 has a switch 142 and a lighting element 144 coupled to the switch 142. In order to correspond to the long and thin shape of the hollow brush handle 12, the lighting circuit board 14 has the shape of a flat rectangle. The two sides of the lighting circuit board 14 have thicknesses slightly less than a width of the slide track 123. Thus, the lighting circuit board 14 can stably slide into the hollow brush handle 12 along the slide track 123 and be fixed to the hollow brush handle 12. The switch 142 is protruded from and mounted in the cavity 122, and the switch 142 and the brush set 102 belong to an identical side. The lighting element 144 corresponds to the first transparent patterned layer 121. The tail cover 16 is provided with an inner thread 162 thereinside, and the inner thread 162 is screwed to the outer thread 124 whereby the tail cover 16 is fixed at the rear end of the hollow brush handle 12.

Since the switch 142 and the brush set 102 belong to the identical side, a user can intuitively and handily press the switch 142 to control the lighting element 144, so that the switch 142 controls the lighting element 144 to emit light, and then the light is projected outside through the first transparent patterned layer 121. In order to response the environmental and energy-saving issue and extend service life, the lighting element 144 is preferably realized with a LED (light-emitting-diode). Certainly, making use of multicolor LEDs can achieve the special visual effect, wherein the white-light LED is also used as spare illumination. Furthermore, due to the fact that the slide track 123 fixes the lighting circuit board 14, the lighting circuit board 14 does not wobble in the hollow brush handle 12 and collide with the inside wall of the hollow brush handle 12 to improve the stability when a user brushes his teeth. In the traditional technology, since no fixed design installed in a toothbrush, a circuit board is easily broken or contact fault of batteries occur whereby the toothbrush is not normally used. The abovementioned traditional problem can be also solved in the present invention.

The lighting circuit board 14 is provide with a power supply 146 coupled to the switch 142 and the lighting element 144 and arranged between the switch 142 and the lighting element 144. The power supply 146 provides power to the lighting circuit board 14. The power supply 146 is a plurality of button batteries which are replaceable to improve convenience and application elasticity.

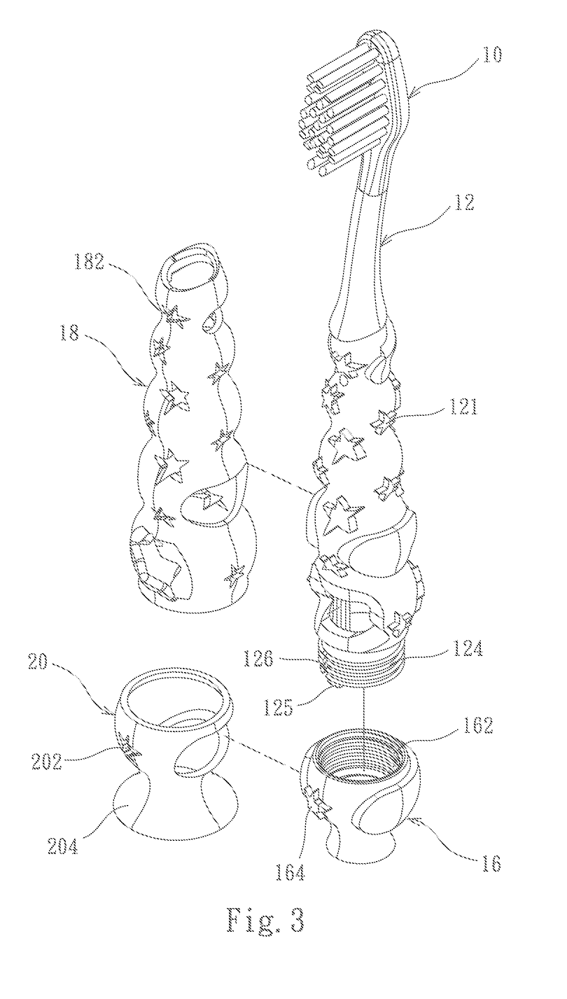

Refer to FIG. 3 which is schematically diagram according to another embodiment of the present invention. The operation of the embodiment is the same as that of the above-mentioned embodiment so will not be reiterated. The embodiment is different from the above-mentioned embodiment in the following: The hollow brush handle 12 is further provided with a located block 125 inside. The tail cover 16 has a located recess (not shown) inside. The located recess is inserted with the located block 125. A cushion groove 126 is longitudinally formed on the outer thread 124 of the hollow brush handle 12, and the cushion groove 126 is arranged near the located block 125. During the process of screwing the inner thread 162 of the tail cover 16 to the outer thread 124, the cushion groove. 126 provides the cushion force between the threads and improves the precision for screwing, so as to reduce the loss of the threads and extend their life.

The lighting toothbrush structure further comprises a brush handle protection case 18 sleeving around the hollow brush handle 12. The brush handle protection case 18 is provided with a plurality of first patterned cavities 182. The positions and shapes of the first patterned cavities 182 correspond to those of the first transparent patterned layer 121. The first transparent patterned layer 121 is in form of a plurality of first transparent patterned bumps, and the first patterned cavities are respectively inserted with the first transparent patterned bumps 182. Each first transparent patterned bump 182 has a height equal to a depth of each the first patterned cavity. Thereby, the first transparent patterned bumps 182 are level with the external surface of the brush handle protection case 18 to demonstrate a smooth design. Besides, the brush handle protection case 18 is made of soft rubber, which makes a user feel more comfortable and soft when the user holds the brush handle protection case 18, and which increases slip-proof capability to favor force application, and which improves usage intention, especially for children and hand-disabled people.

Certainly, in addition to the brush handle protection case 18, the lighting toothbrush structure further comprises a tail cover protection case 20 sleeving around the tail cover 16. The tail cover protection case 20 is provided with a plurality of second patterned cavities 202, and the positions and shapes of the second patterned cavities 202 correspond to those of a second transparent patterned layer 164 of the tail cover 16. The second transparent patterned layer 164 is in form of a plurality of second patterned bumps, and the second patterned cavities 202 are respectively inserted with the second patterned bumps. The tail cover protection case 20 matches the appearance and patterns of the brush handle protection case 18, such as wavelike appearance and transparent starlike patterns. Doubtlessly, the appearance and patterns of the tail cover protection case 20 can change according to the market demand. Consequently, the present invention can add either the brush handle protection case 18 or the tail cover protection case 20. Alternatively, the present invention can add both the brush handle protection case 18 and the tail cover protection case 20.

Wherein, the tail cover protection case 20 further comprises a sucker 204 made of soft rubber. The sucker 204 can support the whole weight and suck a smooth plane, so as to save the expense of a tooth brush holder. The sucker 204 is effectively fixed on but not drops from the smooth plane, and has economic benefits.

In conclusion, the lighting toothbrush structure of the present invention is suitable for users of all ages. Due to the convenience for the brush set and the switch at the same side, the user can intuitively and handily control the lighting period and the switching operation. When the lighting element emits a light through a transparent layer with patterns such as starlike patterns, pumpkin patterns, or other patterns, the light has the shape corresponding to these patterns. Therefore, the present invention features entertainment, practicality and illumination, meets human requirements and increases customer acceptance.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A lighting toothbrush structure comprising:
a brush head provided with a brush set;
a hollow brush handle provided with a first transparent patterned layer and a cavity, and at least one slide track is arranged on an inside wall of said hollow brush handle, and a front end of said hollow brush handle connects with said brush head, and an outer edge of a rear end of said hollow brush handle is provided with an outer thread;
a lighting circuit board having a switch and a lighting element coupled to said switch, and said lighting circuit board is arranged in said hollow brush handle by using said slide track, and said switch is protruded from and mounted in said cavity, and said switch and said brush set belong to an identical side, and said switch controls said lighting element to emit light, and said light is projected outside through said first transparent patterned layer; and
a tail cover provided with an inner thread inside, and said inner thread is screwed to said outer thread whereby said tail cover is fixed at said rear end of said hollow brush handle.

2. The lighting toothbrush structure according to claim 1, wherein said hollow brush handle is further provided with a located block inside, said tail cover has a located recess inside, and said located recess is inserted with said located block.

3. The lighting toothbrush structure according to claim 2, wherein a cushion groove is longitudinally formed on said outer thread of said hollow brush handle, and said cushion groove is arranged near said located block.

4. The lighting toothbrush structure according to claim 1, wherein said lighting circuit board is provide with a power supply coupled to said switch and said lighting element and arranged between said switch and said lighting element, and said power supply provides power to said lighting circuit board.

5. The lighting toothbrush structure according to claim 1, further comprises a brush handle protection case sleeving around said hollow brush handle, and said brush handle protection case is provided with a plurality of first patterned cavities, and positions and shapes of said first patterned cavities correspond to those of said first transparent patterned layer, and said first transparent patterned layer is in form of a plurality of first transparent patterned bumps, and said first patterned cavities are respectively inserted with said first transparent patterned bumps.

6. The lighting toothbrush structure according to claim 1, further comprises a tail cover protection case sleeving around said tail cover, and said tail cover protection case is provided with a plurality of second patterned cavities, and positions and shapes of said second patterned cavities correspond to those of a second transparent patterned layer of said tail cover, and said second transparent patterned layer is in form of a plurality of second patterned bumps, and said second patterned cavities are respectively inserted with said second patterned bumps.

7. The lighting toothbrush structure according to claim 6, wherein said tail cover protection case further comprises a sucker sucking a plane.

8. The lighting toothbrush structure according to claim 5. further comprises a tail cover protection case sleeving around said tail cover, and said tail cover protection case is provided with a plurality of second patterned cavities, and positions and shapes of said second patterned cavities correspond to those of a second transparent patterned layer of said tail cover, and said second transparent patterned layer is in form of a plurality of second patterned bumps, and said second patterned cavities are respectively inserted with said second patterned bumps.

9. The lighting toothbrush structure according to claim 8, wherein said tail cover protection case further comprises a sucker sucking a plane.

10. The lighting toothbrush structure according to claim 1, wherein said lighting element is a LED (light-emitting-diode).
